(19) United States
(12) Patent Application Publication
(10) Pub. No.: US 2024/0256878 A1
(43) Pub. Date: Aug. 1, 2024

(54) DEEP LEARNING ENTITY MATCHING SYSTEM USING WEAK SUPERVISION

(71) Applicant: Walmart Apollo, LLC, Bentonville, AR (US)

(72) Inventors: Neil Palleti, Cupertino, CA (US); Antriksh Shah, Gandhinagar (IN); Ashraful Arefeen, Albany, CA (US); Saigopal Thota, Fremont, CA (US); Sreenaadh Sreekumar, Ernakulam (IN); Mridul Jain, San Jose, CA (US); Nishad Kamat, Los Altos, CA (US); Rijul Magu, Atlanta, GA (US)

(73) Assignee: Walmart Apollo, LLC, Bentonville, AR (US)

(21) Appl. No.: 18/103,559

(22) Filed: Jan. 31, 2023

(51) Int. Cl. G06N 3/0895; G06N 5/01

(52) U.S. Cl. CPC G06N 3/0895; G06N 5/01

(57) ABSTRACT

A system comprising one or more processors and one or more non-transitory computer-readable media storing computing instructions that, when executed on the one or more processors, cause the one or more processors to perform functions comprising: generating pairs of identities from a plurality of sources; for each respective pair of identities of the pairs of identities: determining a match probability for the respective pair of identities using a deep-learning transformer-based binary classification model; and linking the respective pair of identities as nodes on a graph when the match probability meets a predetermined threshold, wherein a linkage between the nodes represents a match for the respective pair of identities; generating, using a connected component algorithm, clusters each containing identities representing a respective user; and generating a respective user profile for the respective user for each cluster. Other embodiments are disclosed.

### TECHNICAL FIELD

This disclosure relates generally to a deep learning entity matching system using weak supervision.

### BACKGROUND

Matching systems used to map events to a same user often rely on conventional approaches using supervised learning and labeled data sets. Such approaches can build fragmented user profiles of the same user due to low coverage.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system for matching different identities associated with a user to create a single user profile for that user, according to an embodiment;

FIG. 4 illustrates an exemplary profile graph showing how a profile graph of a user can be built using nodes and edges representing a user purchasing items using one or more credit cards;

FIG. 5 illustrates a flow chart for a method of acts, modules, and outputs, for matching profiles from multiple identities associated with a user using a profile matching model framework (e.g., architecture), according to an embodiment;

FIG. 6 illustrates a flow chart for a method of acts, modules, and outputs, for generating, using a deep-learning transformer-based binary class machine learning model, a probability of an entity, according to an embodiment;

FIG. 7 illustrates a profile image showing how a true user profile can be constructed;

FIG. 8 illustrates a flow chart for a method, according to an embodiment; and

FIG. 9 illustrates a chart showing how a distribution of merge scored and fragmentation scores for all user clusters created by a production pipeline.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In a number of embodiments, the field of entity matching (EM) can present an industry problem as the technical field of EM covers multiple use cases and/or scenarios. In addition to matching user identities (e.g., customer identities), such scenarios can cover: matching products, creating clusters of similar entities, macro personalization, audience building, etc. In many embodiments, identity resolution approaches can help construct a more accurate single view of each entity or customer. In some embodiments, the term entity can be used interchangeably with the term user. In several embodiments, there many ways to track a user interaction using the internet where a single user can be associated with a diverse array of identifiers, such as online accounts, in-store interactions, external identifiers, transaction history, etc., where each user interaction is assigned a different identifier to the same user. In some embodiments, in order to build a single overarching profile, or entity, for each user, the EM system can group each one of the identities attributed to a single user into one cluster. In several embodiments, data impurities can be found in the multiple identifiers leading to noisy signals (e.g., inaccurate signals) in the data. In some embodiments, sources of the data of each user can include first-party interactions, external data streams, and sparse feature sets, etc., which often contain imprecise data (e.g., impure data) of the user.

Conventionally, designing an accurate view of the user presented an increasingly difficult issue to resolve due to the scale of numerous identifiers where the convention approaches were unable to handle such cases and/or scenarios with a degree of high accuracy or efficiency in this technology field of digital entity matching.

In a number of embodiments, unlike some EM fields, such as product matching, EM for identity resolution lands as a graph modeling problem. In several embodiments, beyond matching individual pairs of identities to each other, as can be done in conventional product matching techniques, building a graph of identities can be based on using an entire set of identities for a given user. An advantage of building the graph of identities allows the system to not only analyze how a set of users are related to each other but also how individual identifiers can define a single profile of a single user. In some embodiments, exploiting the connections (edges) between the identifiers (nodes) for an individual user can be an advantage in order to better understand how a user tends to purchase items whether at individual stores via multiple in-store locations and/or digital channels (e.g., online). In many embodiments, analyzing graphical representations of users can lead to discovering neighborhoods and more complex communities, such as households of users.

In several embodiments, user profile matching can include unsupervised learning used for billions of identities gathered and/or processed where the identities often can include highly sensitive user metadata. In many embodiments, generating manual labels can be infeasible and impractical due to the large scale of the number of identities to process and the privacy of data for each record of a respective identity. In various embodiments, generating training data for a matching algorithm to match profiles can be challenging without using labels assigned to the data (e.g., supervised learning). In many embodiments, evaluating an overall performance of such a matching algorithm used in a matching system can also present large challenges to score the accuracy of the performance.

In various embodiments, conventional EM techniques or systems (e.g., works) primarily revolved around matching items in product catalogs as input data or datasets that can be used to train and/or evaluate matching systems. In some embodiments, datasets can include various and/or different types of attributes for additional systems in addition to using datasets for identity matching.

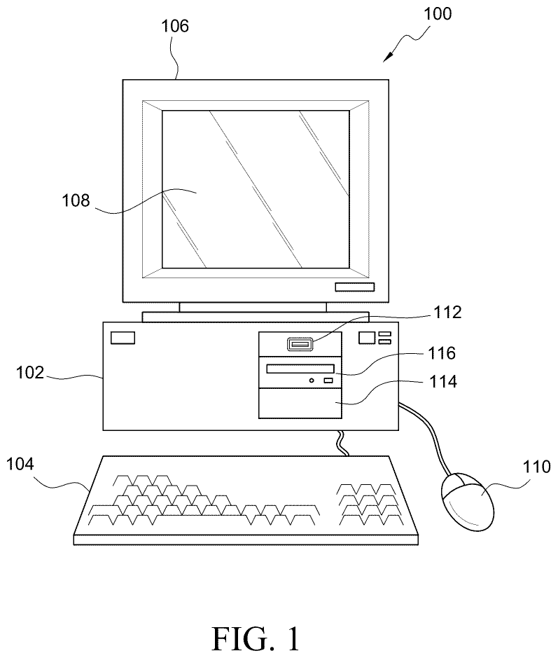

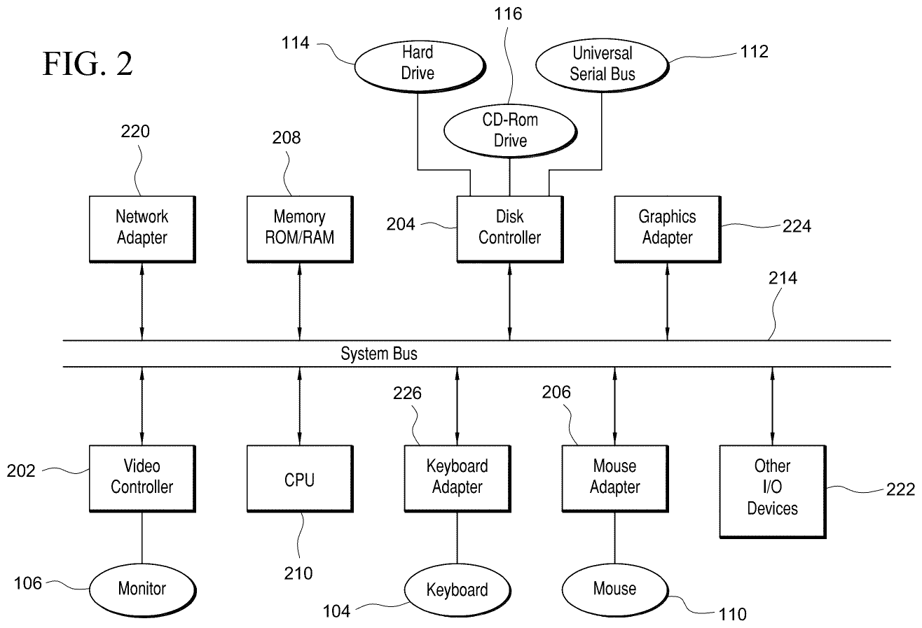

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

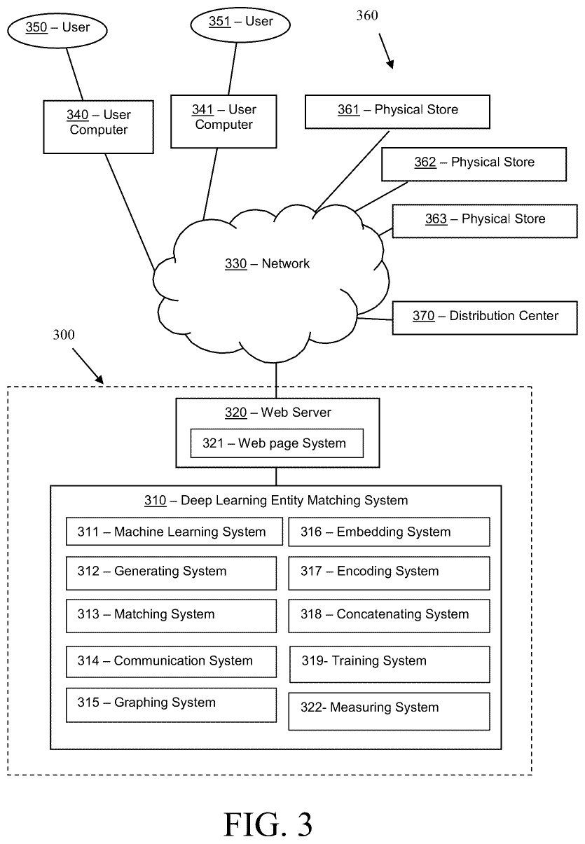

Turning ahead in the drawings, FIG. 3 illustrates a block diagram of a system 300 for matching different identities associated with a user to create a single user profile for that user, according to an embodiment. System 300 also can be utilized to process, using a deep learning entity matching system, billions of user identities using weak supervision learning, according to an embodiment. System 300 further can generate training data, using the deep learning entity matching system, used to train a profile matching algorithm, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a deep learning entity matching system 310 and/or a web server 320. Deep learning entity matching system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, deep learning entity matching system 310 and/or web server 320. Additional details regarding deep learning entity matching system 310 and/or web server 320 are described herein.

In a number of embodiments, each of deep learning entity matching system 310 and/or web server 320 can be a special-purpose computer programed specifically to perform specific functions not associated with a general-purpose computer, as described in greater detail below.

In some embodiments, web server 320 can be in data communication through network 330 with one or more user computers, such as user computers 340 and/or 341. Network 330 can be a public network, a private network or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to create signals, engage or transact with the one or more sites using multiple individual identities, and to generate another suitable type of touch point data whenever users interact with a web server to browse and/or search for items (e.g., products), to add items to an electronic shopping cart, and/or to order (e.g., purchase) items, to create transaction data visiting a brick and mortar store, where the brick and mortar store is linked to ecommerce websites and/or webpages, in addition to other suitable activities.

In some embodiments, an internal network that is not open to the public can be used for communications between deep learning entity matching system 310 and/or web server 320 within system 300. Accordingly, in some embodiments, deep learning entity matching system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage deep learning entity matching system 310, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In a number of embodiments, each of physical stores 360 can be a retail store, such as a department store, a grocery store, or a super store (e.g., both a grocery store and a department store). In many embodiments, the distribution centers (e.g., 370) can provide the items sold at the physical stores (e.g., 360). For example, a distribution center (e.g., 370) can supply and/or replenish stock at the physical stores (e.g., 360) that are in a region of the distribution center. In many embodiments, physical stores (e.g., 360) can submit an order to a distribution center (e.g., 370) to supply and/or replenish stock at the physical store (e.g., 361-363). In many embodiments, distribution center 370 can be referred to as a warehouse or other facility that does not sell products directly to a customer. In many embodiments, users can interact in various ways with physical stores, websites associated with the physical stores, indirectly when orders are filled by physical stores receiving inventory by distribution centers, directly when orders are delivered from distribution centers, and/or another suitable interaction by users mapped or counted as touch point data.

In some embodiments, deep learning entity matching system 310 can be a distributed system that includes one or more systems in each of the distribution centers (e.g., 370). In other embodiments, deep learning entity matching system 310 can be a centralized system that communicates with computer systems in the physical stores (e.g., 360) and distribution centers (e.g., 370). In some embodiments, network 330 can be an internal network that is not open to the public, which can be used for communications between deep learning entity matching system 310, physical stores (e.g., 360), and distribution centers (e.g., 370). In other embodiments, network 330 can be a public network, such as the Internet. In several embodiments, operators and/or administrators of the distributed system of system 300 can manage deep learning entity matching system 310, the processor(s) of system 300, and/or the memory storage unit(s) of system 300 using the input device(s) and/or display device(s) of system 300, or portions thereof in each case.

In several embodiments, deep learning entity matching system 310 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to deep learning entity matching system 310 and/or system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of deep learning entity matching system 310 and/or system 300. In a similar manner, the processors and/or the non-transitory computer-readable media can be local and/or remote to each other.

Meanwhile, in many embodiments, deep learning entity matching system 310 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between deep learning entity matching system 310, network 330, physical stores 360, distribution center 370, and/or the one or more databases can be implemented using any suitable manner of wired and/or wireless communication. Accordingly, deep learning entity matching system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, deep learning entity matching system 310 can include a machine learning system 311, a generating system 312, a matching system 313, a communication system 314, a graphing system 315, an embedding system 316, an encoding system 317, a concatenating system 318, a training system 319, and/or a measuring system 322. In many embodiments, the systems of system 300 can be modules of computing instructions (e.g., software modules) stored at non-transitory computer readable media that operate on one or more processors. In other embodiments, the systems of deep learning entity matching system 310 can be implemented in hardware. Deep learning entity matching system 310 can be a computer system, such as computer system 100 (FIG. 1), as described above, and can be a single computer, a single server, or a cluster or collection of computers or servers, or a cloud of computers or servers. In another embodiment, a single computer system can host deep learning entity matching system 310. Additional details regarding deep learning entity matching system 310 and the components thereof are described herein.

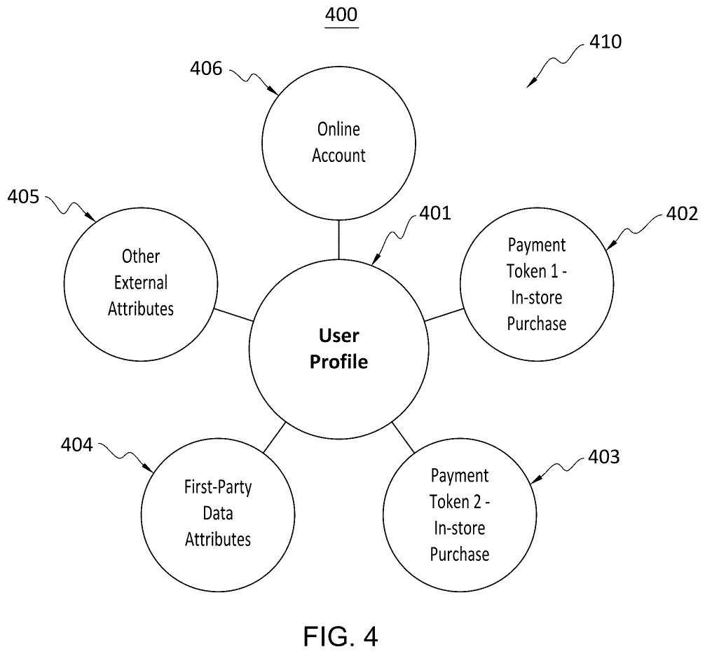

Turning ahead in the drawings, FIG. 4 illustrates an exemplary profile graph 400 showing how a profile graph of a user can be built using nodes and edges representing a user purchasing items using one or more credit cards. Profile graph 400 represents interactions by the user each time an interaction is tracked, such as, each purchases for a respective item or items while in a physical store, a digital interaction (e.g., an online account) or social media, and by each method of payment used during a respective transaction, (e.g., multiple credit cards associated with a user).

As shown in FIG. 4, profile graph 400 illustrates how a central node representing a single user can connect with multiple edges with other nodes. In many embodiments, profile graph 400 illustrates how each node can represent a purchase or transaction using two different credit cards associated with the single user. In several embodiments, the external nodes connected to the user profile node 401 can represent historical purchases or transactions implemented by the user with a particular credit card, such nodes can include nodes 402-406, collectively representing a true identity of a single user. In some embodiments, profile graph 400 can illustrate user profile created when the single user used two different credit cards to purchase items from multiple sources collectively associated with user profile node 401. As an example, a pair of nodes (e.g., 401 and 402) can be connected by an edge when the user used a credit card for an in-store purchase (node 402). In following the example, pair of nodes 401 and 406 can be connected by another edge when the user used a different credit card for an online purchase (node 406).

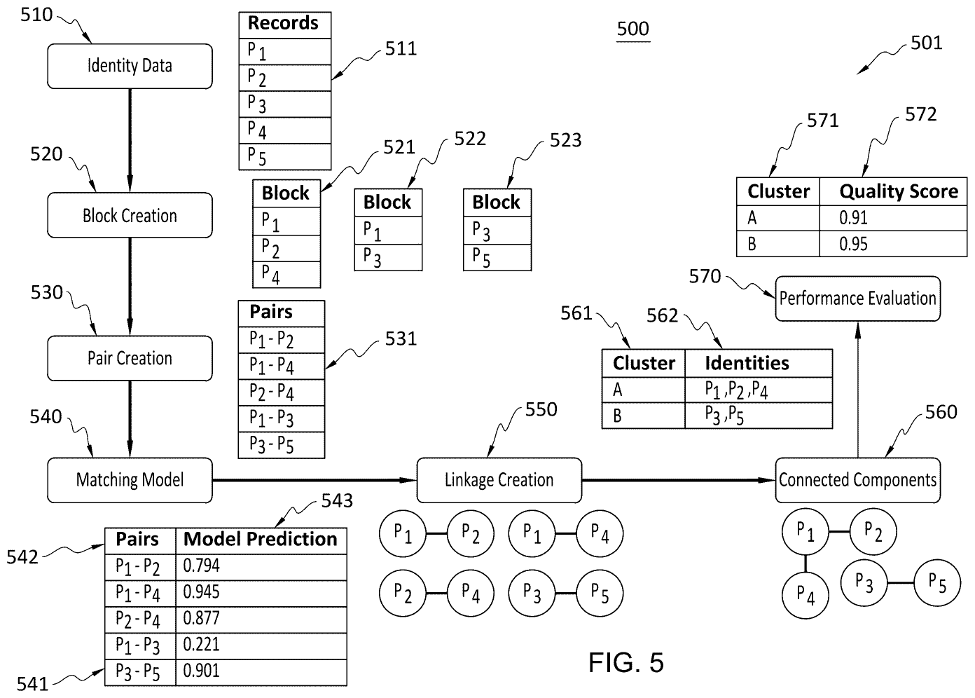

In a number of embodiments, prior to generating the profile graph 400, each image and/or textual representation of a respective purchase, transaction, interaction with a web page, a respective payment method, and/or another suitable interaction, can be converted into a respective vector format or a vector representation in order to create a graphical representation of the user profile. For example, each of the nodes can include a vector or vector representation of a historical purchase and/or transaction made by the same user using one or more respective payment methods, such as a credit card. In some embodiments, profile graph 400 can illustrate a user profile connected by one or more vectors representing a payment method for an item. For example, node 406 can be a vector representation of an online account for a user that used a particular credit card for an online transaction. In following another example, node 403 can be a vector representation of another or the same payment method used by the same user for another different in-store purchase of an item. Similarly, node 404 can be a vector representation of a first-party data attribute, and node 405 can be a vector representation of other external attributes. In several embodiments, converting images and texts into a respective vector format or a vector representation in order to create a graphical representation of the user profile can be similar or identical to the activities described in blocks 510 and 511 (FIG. 5) below.

In several embodiments, each node, such as nodes 402, 403, 404, 405, and/or 406, can be generated from labeled or unlabeled data. In many embodiment, when data representing a node is unlabeled data, weak supervision learning can be used to label the unsupervised data thus, now able to use the data as input data or training data for a profile matching machine learning model. In several embodiments, profile graph 400 can used data points from records as shown below in connection with Table 1.

In various embodiments, profile graph 400 can be used to identify whether or not the purchases were made by the same user based on data from different credit cards. In several embodiments, creating a profile graph 400 can be similar or identical to the activities described below in connection FIG. 5.

Moving forward in the drawings. FIG. 5 illustrates a flow chart for a method 500 of acts, modules, and outputs, for matching profiles from multiple identities associated with a user using a profile matching model framework (e.g., architecture), according to an embodiment. Method 500 also can be utilized for generating connected components from clusters of identities, according to an embodiment. Method 500 further can be utilized for evaluating a performance of the clusters output by the profile matching algorithm, according to an embodiment. Method 500 additionally can illustrate a data pipeline beginning with identifying data records of a user, predicting likelihood probability scores for candidate pairs, and creating connected components (e.g., a graph) using the linkage creation of matching user profile pairs creating a true profile a user. Method 500 is merely exemplary and is not limited to the embodiments presented herein. Method 500 can be employed in many different embodiments and/or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as deep learning entity matching system 310 and/or web server 320. The processor(s) can be similar or identical to the processor(s) described above with respect to computer system 100 (FIG. 1).

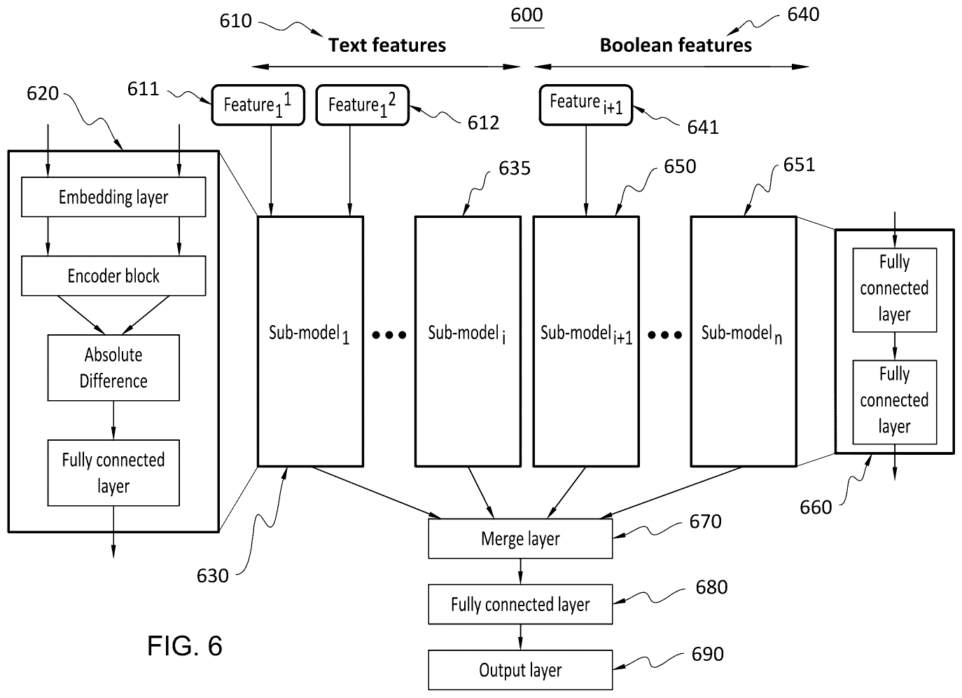

Referring to FIG. 5, method 500 can include a block 510 of retrieving identity data from records associated with a user. In some embodiments, block 510 can include a block 511 of creating records based on user behavior, user identifiers, transaction type (e.g., hashed transaction token), and/or another suitable type of identity data. In a number of embodiments, prior to generating the records, each image and/or textual representation of a respective purchase, transaction, interaction with a web page, a respective payment method, and/or another suitable interaction, can be converted into a respective vector format or a vector representation in order to create a graphical representation of the record. For example, block 511 can include records for user profiles, P1, P2, P3, P4, and/or P5, where the records are grouped together based upon a common identifier. Similarly, the data used to create records can be similar or identical to data listed in Table 1 involving a married couple, as show below. In several embodiments, converting images and texts into a respective vector format or a vector representation in order to create a graphical representation of the records can be similar or identical to the activities described in (FIG. 6) below.

In several embodiments, identity data can be used as input data for a deep learning system that efficiently builds hundreds of millions of user profiles from billions of individual identities and/or identity data found in records. Such a deep learning algorithm machine learning system can include a profile matching model (POMMEL) system. In various embodiments, the POMMEL system can include the core stages of entity matching pipelines: data ingestion, blocking, matching, and cluster generation. In some embodiments, the POMMEL system can include ingesting customer data from dozens of sources, including first party sources, external data sources, online identifiers, profiles created via physical-store interactions, etc. In many embodiments, different sources can generate different signals thus, the feature sets of all sources are standardized before passing the data through the POMMEL system. In several embodiments, such feature sets of the sources can includes a first name, a last name, an address, an email address, a phone number, transaction metadata, and/or another suitable attribute. In some embodiments, data pre-processing and cleaning steps can include address standardization, email filtering, phone number filtering, purchase processing, external attribute validation, and/or another suitable data processing techniques. In many embodiments, since data coming from different sources often have different metadata, the system can standardize the feature sets by selecting a subset of features that are common between most data sources. In some embodiments, further standardization can include extrapolating information such as addresses and email IDs from missing data, formatting features in a consistent way, etc. In various embodiments, an example of the types of identity data collected and used as input into the POMMEL system can be shown in Table 1, as follows:

TABLE 1
User Data for a Married Couple

| | | | | | | Hashed | |
|---|---|---|---|---|---|---|---|
| | First | Last | | | | Transaction | Other |
| Record | Name | Name | Email | Phone | Address | Token | Identifiers |
| P₁ | Alice | Green | Alice.green@gmail.com | 4729573919 | 736 Second | Token 1 | — |
| | | | | | Street | | |
| | | | | | New York, | | |
| | | | | | NY 10019 | | |
| P₂ | Alics | Green | a.green@gmail.com | 4729573919 | — | — | — |
| P₃ | Alex | Green | alexgreen@yahoo.com | — | 736 Second | Token 2 | — |
| | | | | | Street | | |
| | | | | | New York, | | |
| | | | | | NY 10019 | | |
| P₄ | Alice | Rider | Alice.green@gmail.com | 4729573919 | — | — | — |
| P₅ | A | Green | alexgreen@yahoo.com | — | — | Token 2 | — |

In many embodiments, profile matching can use all of the identities associated with a user to be grouped together into one cluster. The term user can be used interchangeably with the term customer. In some embodiments, profile matching can start with a set of individual identities and/or records of the data, R and process this set of individual identities into a set of non-overlapping customer profiles C. In several embodiments, profile matching can denote the total set of true customers as T, where T₁ can represent the set of true corresponding identities for a single individual. In several embodiments, the goal of profile matching is for each customer profile C₁ to correspond to exactly one true customer and contain all of that customer's identities as shown in equation (1):

$$\begin{matrix}{\sum }_{i = 1}^{\vert C \vert} \vert {C}_{i} \vert = \vert R \vert \\ {C}_{i} ∩ {C}_{j} = 0 ∀ i , j ∈ C , i \neq j \\ {C}_{i} = {T}_{i} ∀ i\end{matrix} . \qquad Equation ( 1 )$$

Where Cᵢ can refer to one customer profile, Cⱼ can refer to another customer profile, and Ti refers to the true identities corresponding to the i-th customer. The mathematical equation on line 1 of equation 1 states that the number of identities in each customer profile that constructed sum up to the total number of identities. Line 2 of the equation 1 states that the customer profiles constructed are non-overlapping (e.g., no two customer profiles with a common identity). Line 3 of equation 1 states that each customer profile constructed matches a set of true identities that belong to that customer.

In several embodiments, a matching pipeline can strive to achieve a set of customer profiles C that is identical to the true set T. In some embodiments, this achievement can be represented by the following statements: (1) |C|=|T| (the number of profiles that the system generates is the same as the total number of true customers), (2) each of the identities of each true customer can be wholly encapsulated in a single profile and not fragmented into multiple profiles, (3) no one cluster can contain or merge the identities of multiple true customers. In many embodiments, method 500 can proceed after block 510 to a block 520.

In various embodiments, method 500 can include a block 520 of creating blocks of groups of records (e.g., profiles) that can share the same user. In several embodiments, blocking groups can include analyzing identities pairwise to determine whether each pair of identities belongs to the same user. In many embodiments, an advantage of performing blocking can include avoiding using a quadratic search space (all pairwise combinations of identities) that can be inefficient and lead to inaccuracy issues. In various embodiments, another advantage of performing blocking can be shown by generating groups and/or “blocks” of user profiles that all have some type of matching quality. For example, types of matching qualities a profile matching system like POMMEL can include creating blocks for all user profiles that have the same address, a same email address, a same phone number, and/or another combination of other attributes.

In several embodiments, block 520 can include blocks 521, 522, and 523 that were grouped as single block as they shared a common trait or identifier. In many embodiments, block 521 can include records P1, P2, and P3, grouped as a single block based on a shared common identifier such as a telephone number. In following this pattern, block 522 can include records P1, P2, and P3 based on common phone number. Similarly, block 523 can include records P3 and P5 based on sharing a common hashed transaction token, and so forth. For example, the data records and/or fields populated in Table 1, above, includes records P1-P5 for a married couple where the records are populated multiple identifiers, such records can be similar or identical to data in the records grouped in blocks 521, 522, and 523. In various embodiments, method 500 can proceed after block 520 to a block 530.

In several embodiments, method 500 can include block 530 of creating pairs of records using data from the blocks created from user records. In some embodiments, creating candidate pairs (N/2) of records can include reconfiguring data output from 520 before passing the candidate pairs to the matching state in this data pipeline. In various embodiments, block 530 can include a block 531 of storing candidate pairs as data used as input for a matching model. For example, the records grouped together in block 521 can be used to create the candidate pairs P₁-P₂, P₁-P₄ and P₂-P₄ based on a common identifier, data point, and/or any other suitable common feature selected for each block. Similarly, records included in blocks 522 and 523 can be used to create candidate pairs, P₁-P₃ and P₂-P₃, respectively where each candidate pair shares a different common identifier. As an example, block 531 can include a collection of candidate pairs matched together from blocks 521,522, and 523. Such a table of candidate pairs can cumulatively include candidate pairs P₁-P₂, P₁-P₄, P₂-P₄, P₁-P₃, P₃-P₅, as shown in block 531 (FIG. 5). In several embodiments, the pairs described in block 531 can be similar or identical to the activities described in blocks 541 and 542 (FIG. 5) as data used for a model predictions. In several embodiments, method 500 can proceed after block 530 to a block 540.

In a number of embodiments, method 500 can include block 540 of determining, using a matching model, a model prediction (e.g., score) for each respective pair of identities. In several embodiments, the matching model can be a transformer-based matching algorithm. Such a pair of identities can be similar or identical to the activities described in block 531. Similarly, the matching model can be similar or identical to the model generated in method 600 (FIG. 6, described below).

In various embodiments, a model prediction can include a score between 0.0 and 1.0, where the closer the number is to 1.0 indicates a higher probability that the two candidate pairs (e.g., pairs, identities) analyzed by the matching model are a match. For example, a table of pairs 542 lists several candidate pairs 541 and model predictions 543 for each candidate pair. In following this example, each of the candidate pairs with respective scores, P₁-P₄ (0.945) and P₃-P₅ (0.901), both have scores closest to 1.0 over the other candidate score pairs indicating the pairs are likely a close match. Whereas, candidate pairs with respective scores: P₁-P₂ (0.794), P₁-P₄ (0.877) both have scores closer to 1.0 over some of the other candidate score pairs also indicating the pairs are likely a close match, also can be an but not as close as the P₁-P₄ (0.945) and P₃-P₅ (0.901). Lastly, in this example, P₁-P₃ (0.221) has a score farther way from 1.0, thus likely not a match.

In some embodiments, conventionally a Rule Based Matching (RBM) approach (e.g., process) was initially used to create linkages when the data was unlabeled (e.g., unsupervised data) by relying mostly on domain knowledge. In some embodiments, RBM created a list of strict conditions and rules to process a different combination of features which led to inaccurate data. In some embodiments, a disadvantage of using the RBM approach included customer identities left with sparsity and noise illustrating an ineffective approach to discover identity matches despite with low coverage. In several embodiments, an advantage in using the POMMEL matching algorithm as an improvement over other conventional approaches includes using a deep learning transformer-based binary classification model that determines whether a pair of identities match using weak supervision learning.

In many embodiments, POMMEL can solve the unlabeled data problem by using labels generated via weak supervision to create training data used to train the matching machine learning model. In some embodiments, this type of a deep learning machine learning model can prove to be more effective in identifying fuzzy identity matches by improving the coverage by over 417% when compared to the conventional RBM approach and/or another conventional method. In many embodiments method 500 can proceed after block 540 to a block 550.

In various embodiments, method 500 can include block 550 of generating linkages, where each identity can be viewed as a node linked to another node. In some embodiments, the data output by the linkage creation can be used to generate the connected components in a graphical manner where each identity is viewed as a node. In many embodiments, method 500 can proceed after block 550 to a block 560.

In some embodiments, method 500 can include block 560 of generating connected component graphs by clusters. In some embodiments, an objective of generating clusters of identities can be to have each cluster point to one entity and/or user (e.g., customer), such as clusters 561 and identities 562. In various embodiments, cluster 561 can include a cluster A of identities 562 (P₁, P₂ and P₄) and a cluster B of identities 562 (P₃ and P₅). In many embodiments, a respective connected component of nodes can be based on the identities in each of cluster. As an example, connected components based on cluster A includes P₄-P₁-P₂. Similarly, connected components based on cluster B includes P₃-P₅.

In several embodiments, a linkage can be created between pairs of identities where the new linkages create reconfigured data within the links that can be input in a connected components algorithm. In some embodiments, the reconfigured data (e.g., linkages) as generated as output from linkage creation (e.g., block 550) can be used as input to run the connected components algorithm and output (e.g., arrive) final clusters, where each cluster of the final clusters can include the identities of exactly one true customer. In many embodiments, method 500 can proceed after block 560 to a block 570.

In a number of embodiments, method 500 can include a block 570 of evaluating, using a score generation algorithm the performance of the clusters using quality scores. In some embodiments, block 570 can evaluate the overall performance of an entity matching (EM) system, such as POMMEL, by employing a statistical scoring method that calculates the quality of the final customer profiles that are generated. Such final customer profiles can be similar or identical to activities of the final customer profiles described above in block 560.

In various embodiments, POMMEL can evaluate the performance of the matching model as output by the overall data pipeline. In some embodiments, a first method can include using the labels generated by a weak supervision model, such as Snorkel, to calculate the accuracy of the model. In several embodiments, there can be no guarantee that the labels as generated by the weak supervision model can be completely accurate, thus generating labels can be an initial model development stage. In many embodiments, another metric that can be used to evaluate the model performance is the total number of connected components generated by a matching algorithm machine learning model, such as POMMEL. In some embodiments, since each connected component can ideally represent one customer, then tracking the total number of components is the simplest way to measure the performance of the data pipeline. In several embodiments, the variable |C| can refer to the number of clusters POMMEL generates that can match |T| which can refer to the true number of customers. In various embodiments, while this metric can serve as a check for the performance of the data pipeline, the total number of clusters can give little information regarding the actual quality of the clusters created by POMMEL.

In several embodiments, an EM system can employ a score generation algorithm shown as Algorithm (1), as follows:

Algorithm 1 Score Generation

| | Input: A = {a₁, ...a_{N}}, υ = {υ₁, ...υ_{N}} |
|---|---|
| | Output: score |
| 1: | Step 1: Formulate each aᵢ in A as a probability distribution pᵢ (x). |
| 2: | score = 0 |
| 3: | Step 2: Generate sub_scores for all meta-attributes: |
| 4: | for i ← 1 to N do |
| 5: | score −= log pᵢ (υᵢ) |
| 6: | end for |
| 7: | Step 3: Normalize score using linear and sigmoid functions: |
| 8: | score = normalize(score) |
| 9: | Return score |

Where v refers to the set of vectors that contain the values associated with each attribute for all customer profiles. Each vector vᵢ contains the metrics of each customer profile for attribute i.

Additionally, A refers to the attributes included in the scoring calculation, such attributes can include metrics such as a number of distinct emails in a customer profile, a number of distinct addresses, graph density, etc.

In several embodiments, a second method can include using the customer clusters that POMMEL generates to evaluate the final results of the data pipeline (e.g., pipeline). In many embodiments, conventionally manual inspection can be used gauge the quality of a cluster, however even with manual inspection, it can be difficult to evaluate the accuracy of clusters. In some embodiments, measuring how fragmented a customer profile Cᵢ is can involve going through the billions of identities R and determining which identities are missing in C₁, thus is an intractable or inefficient way to determine fragmentation of Cᵢ.

In many embodiments, an advantage of POMMEL can using approximations that incorporate domain knowledge to predict the quality of each customer cluster. In some embodiments, there can be two ways a cluster can be considered inaccurate: (1) erroneous merging of identities of multiple customers, or (2) the fragmentation of a single customer's identities into multiple clusters. In some embodiments, a first phenomenon can occur when two or more different customers identities are present in one customer cluster (e.g., merging customers), can cause downstream data to be consider two or more different customers as the same individual (customer, user). The second phenomenon can include the same customer having multiple clusters (e.g., fragmenting one customer), which skews aggregate statistics and leads to incomplete views of such individual clusters.

In several embodiments, in order to measure the performance of a profile matching system, block 570 can compare two novel types of quality scores: a merge score and a fragmentation score. In some embodiments, the merge score can measure how the cluster was erroneously merged or impure. In many embodiments, the fragmentation score can measure how the cluster is fragmented. In several embodiments, the distributions of these two scores can serve as robust performance metrics of the end-to-end matching pipeline.

In many embodiments, calculating each of these scores can be described by the following steps: (1) extracting meta-attributes for each cluster that provides information regarding the quality of the cluster, (2) calculating a sub-score based on each meta-attribute, and (3) aggregating the sub-scores to generate a final score for each cluster.

In various embodiments, each cluster can include any number of individual customer identities, each with their own metadata (e.g., a name, an email, a phone number, an address, purchase information, external identifiers, etc.). In some embodiments, for the merge score, POMMEL can extract meta-attributes that indicate whether the component is impure to check if a cluster contains more than one of different identities of customers. Examples of such attributes can include the number of distinct names, emails, phone numbers, etc. that are present in: (1) the cluster, (2) the cluster's graph density, and (3) the modularity of the customer. In some embodiments, Algorithm (1) can be a method used to produce the merge score and fragmentation score for each customer profile. In several embodiments, these two scores (merge score and fragmentation score) can be used for performance evaluation and logging.

In a number of embodiments, the next stage can be calculating a meaningful sub-score for each of these attributes. In some embodiments, if a cluster contains five distinct names, then the likelihood that the cluster contains more than one customer (and consequently is of poor quality), can be high. In several embodiments, alternatively, if the cluster has one distinct name, one distinct email, and the customer's graph density is high, then it can correspond to only one true customer. Therefore, in various embodiments, in order to calculate sub-scores, first each attribute can be represented as some probability distribution Pᵢ(x) based on domain knowledge. In many embodiments, with some attributes (such as the number of distinct names, emails, addresses, etc.), the lower the attribute value, the higher the likelihood that the cluster is pure. In some embodiments, for such attributes, exponential distributions can be chosen or selected to represent the attributes.

In various embodiments, a cluster with high graph density can be more likely to be pure, since more pairs of identities within the cluster have all gone through the matching model and were predicted to be linked together (which serves as additional validation).

In several embodiments, sub-scores of the remaining attributes can be represented with normal distributions. In many embodiments, mean and variance values for each normal distribution can be chosen using domain knowledge. For example, since it is more common for customers to have multiple distinct emails and phone numbers than names, then the email and phone number distributions have higher mean values and greater variances. In several embodiments, deriving these signals at the cluster level can provide more information regarding the quality of a cluster than merely analyzing identities pairwise.

In a number of embodiments, in order to calculate the fragmentation score, POMMEL can follows the same steps as above but uses different cluster meta-attributes. As an example, let C₁ denote a cluster that POMMEL has generated for use in calculating a fragmentation score for that cluster. Let C₁ correspond to the true customer T₁. In following this example, in order to measure how fragmented a customer cluster C₁ is, determine whether any of T₁'s identities are present in clusters other than C₁ as this would indicate that C₁ is incomplete and therefore fragmented.

In various embodiments, without the presence of supervised labels, POMMEL can extract other meta-attributes that can point to fragmentation of the customer cluster. In many embodiments, for each cluster, POMMEL can calculate the number of other clusters that contain matching attributes. For example, if C₁ contains an email address that is also present in three other clusters, this can indicate a possibility of a cluster fragmentation. In following this example, similarly, if a phone number, hashed transaction token, address, email, etc., are shared among other clusters, this can also indicate or point to potential cluster fragmentation. In several embodiments, the higher the number of customer clusters with matching attributes, the greater the likelihood that a given cluster can be fragmented. In some embodiments, an advantage of POMMEL can be by using exponential distributions to fit the scoring criteria for these meta-attributes, then lower-valued attributes can lead to a higher quality score regarding fragmentation of clusters.

In several embodiments, POMMEL can be advantageous by calculating the meta-attributes for all customer clusters. In many embodiments, for each attribute aᵢ, select and fit the appropriate probability distribution pᵢ(x) to the parameters defined via domain knowledge and aggregate statistics. In some embodiments, in order to generate a score s using the attribute vector v (where vᵢ denotes the value of attribute i for the cluster), aggregate the sub-scores and normalize using Equation 2:

$$\begin{matrix}{s}^{′} = m [ {\sum }_{i} - log ( {p}_{i} ( {v}_{i} ) ) ] + c \\ s = 1 - σ ( {s}^{1} )\end{matrix} \qquad Equation 2$$

Where, the variables m and c refer to manually chosen values that apply a linear transformation while calculating the final score of each customer profile. This is performed to make the scores more interpretable when using them for performance evaluation. These values can be changed for each use case. The variable s′ refers to the intermediate score before it is passed into the sigmoid function.

In some embodiments, since the sub-scores can encapsulate probabilities associated with various meta-attributes, aggregate the sub-scores in a similar fashion to how probabilities are aggregated. In many embodiments, when dealing with independent variables, a joint probability can be calculated by multiplying the individual probability values.

In several embodiments, despite meta-attributes potentially being correlated with each other, calculating the sub-scores can include making an approximation and treating the meta-attributes as independent values. In various embodiments, by applying a sigmoid function to this sub-score to bring the score between 0.0 and 1.0, where 1.0 represents the highest possible quality. In some embodiments, before passing this score into the sigmoid function, apply a linear transformation to s′ (m and c are hyperparameters tuned such that the sigmoid function outputs meaningful scores in the range of 0 and 1). In various embodiments, use the same or similar method to create merge scores and fragmentation scores with the difference being the meta-attributes and their respective distributions.

In some embodiments, generating a final score of each customer profile, the sub-scores for each attribute can be calculated. In several embodiments, first sum together each negative logarithm of the probability of the value of each metric of a given customer profile, then apply a linear transformation (which is what the terms m and c represent) based on domain knowledge. In some embodiments, to get the final score, take the sigmoid and subtract it from 1. In many embodiments, this step allows each score to be within ranges between 0 and 1, where 0 is the lowest possible score and 1 is the highest possible score.

Turning ahead in the drawings. FIG. 6 illustrates a flow chart for a method 600 of acts, modules, and outputs, for generating, using a deep-learning transformer-based binary class machine learning model, a probability of an entity, according to an embodiment. Method 600 also can be utilized for generating a probability of an entity match. Method 600 also can be utilized for generating, using a deep-learning transformer-based binary class machine learning model, a probability of an entity. Method 600 is merely exemplary and is not limited to the embodiments presented herein. Method 600 can be employed in many different embodiments and/or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped. In several embodiments, system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as deep learning entity matching system 310 and/or web server 320. The processor(s) can be similar or identical to the processor(s) described above with respect to computer system 100 (FIG. 1).

In some embodiments, POMMEL's matching model (e.g., deep-learning transformer-based binary class machine learning model) can process a pair of identities C₁ and C₂ and use the pair of identities as input to generate the probability of an entity match between the pair of identities. In several embodiments, each identity in every pair of identifies can consist of two kinds of features or values: (1) raw textual attributes (e.g, text features) and (2) boolean values (boolean features).

In several embodiments, the deep-learning transformer-based binary class machine learning model (e.g., POMMEL architecture) can process or handle the different input attributes separately using two types of sub-models, that each process a certain feature, simultaneously in parallel: (1) textual sub-models and (2) boolean sub-models.

In many embodiments, method 600 can include a block 610 of inputting text features (e.g., raw textual attributes) for each entity pair. In several embodiments, block 610 can include receiving text features 611 and text features 612. In various embodiments, prior to using text features 611 and text features 612 as input in to block 620, each text feature can be transformed into unique string length distributions. In various embodiments, examples of text features can include a name, an address, an email, a phone number, where each feature having a unique string length distribution.

In various embodiments, before a textual feature can be passed into its corresponding sub-model iteration, text features 611 and text features 612 can be converted to a character-level encoding feature by converting the raw text into a numeric representation. In several embodiments, unlike conventional product matching approaches, which can process long textual descriptions of products (e.g., items), identity matching can include highly unique attributes, such as names, emails, addresses, and/or another suitable unique identity attribute. In various embodiments, rather than using word-level encodings and embeddings as product matching systems do, creating character-level encoding (e.g., representation) can convert raw text into a format usable by the deep-learning transformer-based binary class machine learning model.

In some embodiments, method 600 can include a block 620 of removing sparsity from the character-level encoding passed into an embedding layer. In many embodiments, block 620 can proceed after the embedding layer to an encoder block by passing the reconfigured data output from the embedding layer into the encoder block.

In several embodiments, block 620 additionally can include processing the reconfigured data to the encoder block, which consists of a transformer using multi-head attention, can be followed by a fully connected layer. In many embodiments, given recent advancements in Natural Language Processing (NLP) problems, transformers can be the models of choice over recurrent neural networks (RNNs) and bidirectional long short-term memory (LSTM) models, as the transformers can advantageously exhibit superior performance both in accuracy and efficiency due to the parallelized architecture.

In some embodiments, the encoder block can generate final encodings for each textual feature of both C₁ and C₂. In various embodiments, at this stage, block 620 can follow the Siamese architecture style, meaning the encoder block is shared between a given textual feature of C₁ and C₂. In a number of embodiments, block 620 can include calculating the absolute difference of encodings of corresponding attributes. For example, the absolute difference of encodings can include calculating the difference in encodings for the first names of identities C₁ and C₂.

In several embodiments, block 620 additionally can include the differences of each feature encoding is passed into a fully connected layer which is the last stage of the textual sub-model. In various embodiments, each sub-model can be advantageously trained to create meaningful similarity measurements of a unique pair of features. For example, a first name, a last name, an email, etc., each have their own sub-model that learns its respective feature's semantic information.

In several embodiments, method 600 can include a block 630 of processing a series of textual sub-models. Method 600 also can include a block 635 of processing the last textual sub-model of the series of textual sub-models. In many embodiments, the number of iterations selected to run each textual sub-model can be based on exceeding a predetermined number of iterations. In many embodiments, method 600 can proceed after blocks 630 and 635 to a block 670.

In some embodiments, method 600 also can include a block 640 of inputting Boolean features (e.g., values) for each entity pair. In a number of embodiments, other qualities of an identity, such as external metadata and transaction history, are stored as Boolean features. In many embodiments, unlike textual features, boolean features 641 can be used as input into boolean sub-models.

In several embodiments, block 640 also can include a block 651 of running boolean sub-models, each of which can consist of fully connected layers (e.g. block 660). In some embodiments, block 640 can include block 660 of inputting the Boolean features into two fully connected layers where each of the outputs of each boolean sub-model are then concatenated and passed into a final fully connected layer. In many embodiments, block 640 further can include a block 650 of a final Boolean sub-model in a series of boolean sub-models. In various embodiments, method 600 can proceed after blocks 650 and 651 to a block 670.

In various embodiments, method 600 additionally can include a block 670 of merging layers. In some embodiments, the merge layer merges the outputs of all intermediate subnetworks by concatenating them. In several embodiments, the concatenated output can be sent to a final fully connected neural network layer which makes the final prediction. In various embodiments, such steps can be advantageous by outputting a more robust prediction by combining information from all features. In many embodiments, method 600 can proceed after block 670 to a block 680.

In several embodiments, method 600 further can include block 680 of inputting reconfigured data output by block 670. In some embodiments, a fully connected layer can process the intermediate neural network features and produce a final prediction. In various embodiments, the concatenated information from the previous neural network layers can including outputting the final prediction via the output layer. In many embodiments, method 600 can proceed after block 680 to a block 690.

In some embodiments, method 600 also can include a block 690 of outputting the probability of an entity match. In many embodiments, the output an end with a single neuron layer with a sigmoid activation function. In several embodiments, dropout layers and L2 regularization can be used to prevent over-fitting the machine learning model (e.g., deep-learning transformer-based binary class machine learning model). In some embodiments, the machine learning model can be trained using Adam RMSprop with Nesterov momentum and/or a mini-batch size of 1024. An advantage of the training configurations can include a combined benefit of avoiding overfitting and faster convergence to optimal system performance.

In various embodiments, method 600 can include using the binary cross-entropy loss function to tune the weights using in the machine learning model to ensure the model does not output different predictions based on the order of the identities C₁ and C₂, thus, the input pairs of user profiles are randomly reversed with probability 0.5. In some embodiments, when a pair (Cᵢ, Cⱼ) is reversed, the model can receive (Cⱼ, Cᵢ) as input which is advantageous by helping the model become more symmetric when making predictions. In many embodiments, an advantage of using the binary cross-entropy loss function can benefit the system to avoid biases regarding the ordering of customer identities when passed into the model, thus increasing the system's robustness.

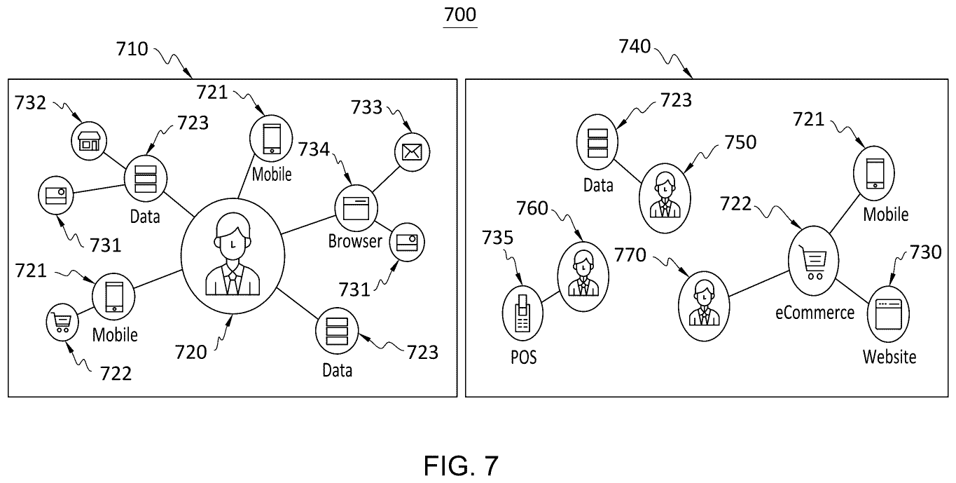

Turning ahead in the drawings FIG. 7 illustrates a profile image 700 showing how a true user profile can be constructed. Profile image 700 includes a user profile 710 and a user profile 740. User profile 710 illustrates how a true profile can be constructed for a customer. For example, the true profile for a customer illustrates multiple interactions by the user connected back to user 720 from in-store interactions, digital interactions, and/or other interactions. As an example, the connections can include an interaction with electronic devices such as mobile device 721, browser 734, email 733, database 723, payment methods such as credit card 731, in-store interaction 732, shopping cart 722, and/or other interactions connected to the user 720 in this user profile.

In various embodiments, due to sparsity in some customer identities, it can be challenging for the pipeline to connect all the in-store, digital, and other interactions a customer makes, thus multiple profiles can be used for the same customer, as illustrated in user profile 740. User profile 740 illustrates how a true profile that is fragmented can be constructed for a customer. In several embodiments, multiple profiles for the same customer can be illustrated as customer profiles 750, 760, and 770, created for the same customer. For example, an interaction stored as data 723 is connected only to customer profile 750 even though customer profile 760 and 770 are the same as customer profile 750 due to sparsity in customer identities. Similarly, a transaction at a point of sale 735 is only connected to customer profile 760 whereas interactions using a mobile device 721, shopping cart 722 and a website 730 are all connected only to customer profile 770. In various embodiments, identifying which customer profiles are likely fragmented can be involved in evaluating the end-to-end performance of the entity matching system to create a single true user profile.

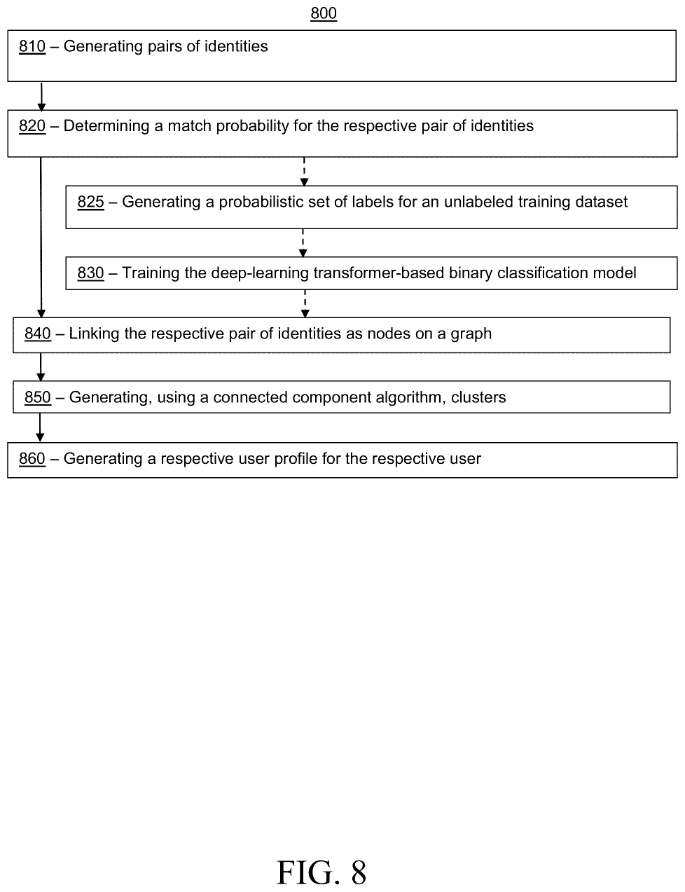

Moving ahead in the drawings, FIG. 8 illustrates a flow chart for a method 800, according to another embodiment. Method 800 can be employed as a method of constructing user profiles from the billions of user identities output by the deep learning entity matching system in the form of graphs. In some embodiments, method 800 also can be a method of automatically generating labels to train a profile matching algorithm using weak supervision. Method 800 is merely exemplary and is not limited to the embodiments presented herein. Method 800 can be employed in many different embodiments and/or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped. In several embodiments, system 300 (FIG. 3) can be suitable to perform method 800 and/or one or more of the activities of method 800.

In these or other embodiments, one or more of the activities of method 800 can be implemented as one or more computing instructions configured to run at one or more processors and configured to be stored at one or more non-transitory computer-readable media. Such non-transitory computer-readable media can be part of a computer system such as deep learning entity matching system 310. The processor(s) can be similar or identical to the processor(s) described above with respect to computer system 100 (FIG. 1).

Referring to the drawings, method 800 can include a block 810 of generating pairs of identities from a plurality of sources. In several embodiments, block 810 can be implemented as described above in connection with blocks 510, 520, and/or 530 of FIG. 5.

In some embodiments, for each respective pair of identities of the pairs of identities, method 800 also can include a block 820 of determining a match probability for the respective pair of identities using a deep-learning transformer-based binary classification model. In several embodiments, a profile matching machine learning model can include a Profile Matching Model (“POMMEL”) architecture that can be an end-to-end deep learning entity matching system that processes billions of user identities and constructs user profiles from them in the form of graphs. In many embodiments, POMMEL can advantageously address the problem of matching customer signals with a high degree of precision and coverage by overcoming the challenge of the lack of supervision for the user data and/or identities. In several embodiments, POMMEL can overcome the unsupervised nature of identity matching using: 1) weak supervision methods to generate labels to train data for a matching algorithm machine learning model, and 2) a statistical approximation to measure performance of an entity matching system when lacking labeled data (e.g., weak supervision learning). In many embodiments, block 820 can be implemented as described above in connection with block 540 of (FIG. 5) and/or blocks 670, 680, and/or 690 of (FIG. 6).

In several embodiments, method 800 optionally can include a block 825 of generating a probabilistic set of labels for an unlabeled training dataset to output a labeled training dataset. In some embodiments, after generating candidate pairs of identities through blocking, block 825 can develop a model capable of predicting whether two identities belong to the same customer. In various embodiments, given an input data point consisting of a pair of identities C₁ and C₂, the model outputs a binary label y representing whether the two identities match. In many embodiments, in order to create this matching system, the model can be trained on a large amount of diverse labelled data. In several embodiments, labelling customer data can be a significant challenge due to (1) the amount of data involved in training the model and (2) privacy requirements regarding customer data. In some embodiments, conventional use of manually labelling the data in-house and/or sending the data to third-party labelling teams can be infeasible and inefficient approaches.

In various embodiments, in order to over-come conventional labelling of customer data issues, POMMEL can employs a weak supervision learning model, such as Snorkel, to generate the labelled training dataset. In several embodiments, Snorkel is a weak supervision data programming tool that uses heuristic functions to generate labels. In various embodiments, heuristic functions can be written to perform labelling functions that can be processed through Snorkel's algorithm. In many embodiments, a weak supervision model, such as Snorkel, can first process the unlabelled training dataset and second generate probabilistic labels. In some embodiments, a profile matching model deep learning model (e.g., POMMEL) can use the labelled data as a training data set. In many embodiments, the training data set can be used to train the profile matching deep learning model. In several embodiments, block 825 can be implemented as described above in connection with blocks 560, 561, and/or 562 (FIG. 5) and/or block 690 (FIG. 6).

In many embodiments, block 825 of generating the probabilistic set of labels can include using heuristic functions. In some embodiments, for every data point, each heuristic function can compare the values of the pair of identities for one or more features. In several embodiments, a heuristic function returns a positive label 1 (two identities of the data point correspond to one individual), negative label −1 (two identities correspond to two different individuals), or abstains from generating a label with 0 (not enough information to make a decision) for each data point. For example, the name feature has one associated heuristic function that uses edit distance, name initials, designation, name swapping, nick names, etc. to output a label by looking at the first and last names of two identities. Similarly, there are labeling functions that each can process addresses, emails, phone numbers, transactional metadata, and other features. In many embodiments, block 825 can be implemented as described above in connection with blocks 540 and/or 550 (FIG. 5) and/or blocks 610, 620, 630, 635, 640, 650, 651, and/or 660 (FIG. 6).

In some embodiments, creating labeling functions for features that are easily interpretable by domain experts can be straightforward, but the deep learning model also processes some features that are more complex. In several embodiments, these features, such as complex external metadata, cannot be used during the labeling stage but rather can be passed to the deep learning model during training and inferencing to provide additional information. In various embodiments, by doing so, the deep learning model can learn from dimensions of data that can be too complex to write labeling functions, thus opting to use a weak supervision model, such as Snorkel, to run the unlabeled dataset X=(X₁, X₂, . . . , X_{N}) through the M heuristic functions. In some embodiments, each function ƒᵢ(x) returns its own reconfigured data set of labels and can be denoted by vector li containing labels from the classes (−1, 0, 1). In several embodiments, the group of label vectors is represented as an M×N matrix L. In various embodiments, the weak supervision model, such as Snorkel's algorithm, can process L through its generative model, appropriately handle dependencies, correlations, and the potential overlapping nature of heuristic functions to output final probabilistic labels for the dataset and/or training dataset. In several embodiments, the generative model can be a factor graph that minimizes a negative log likelihood function using stochastic gradient descent and/or Gibbs sampling. In some embodiments, POMMEL can advantageously use Snorkel to generate labels for approximately one million data points. In several embodiments, POMMEL can then uses the labelled data points as the training dataset for the deep learning profile matching model. In many embodiments, block 825 can be implemented as described above in connection with blocks 640, 641, 650, 651, and/or 660 (FIG. and 6).

In various embodiments, block 825 of generating the probabilistic set of labels can include using a weak supervision model. In several embodiments, after generating candidate pairs of identities through blocking, block 825 can develop a deep learning model capable of predicting whether two identities belong to the same customer. In some embodiments, method 800 can proceed after block 820 to a block 830.

In a number of embodiments, method 800 optionally can optionally include block 830 of training the deep-learning transformer-based binary classification model using the labeled training dataset. In many embodiments, block 830 can be implemented as described above in connection with blocks 610, 640, 670, 680, and/or 690 (FIG. 6).

In various embodiments, for each respective pair of identities of the pairs of identities, method 800 further can include a block 840 of linking the respective pair of identities as nodes on a graph when the match probability meets a predetermined threshold. In several embodiments, block 840 can include a linkage between the nodes that can represent a match for the respective pair of identities. In many embodiments, block 840 can be implemented as described above in connection with blocks 550, and/or 560 (FIG. 5).

In several embodiments, block 840 can include determining the match probability by obtaining textual features for each identity of the respective pair of identities. In some embodiments, each of the textual features can include unique string length distributions. In various embodiments, block 840 of determining the match probability also can include generating a first sub-model based on the textual features. In many embodiments, block 840 can be implemented as described above in connection with block 610, 620, 630 and 635 (FIG. 6).

In some embodiments, block 840 of determining the match probability further can include obtaining boolean features for each identity of the respective pair of identities. In several embodiments, the boolean features can include external metadata and transaction history. In some embodiments, determining the match probability also can include generating a second sub-model based on the boolean features. In many embodiments, block 840 can be implemented as described above in connection with blocks 640, 650, 651, and 660 (FIG. 6).

In several embodiments, block 840 of generating the first sub-model also can include generating character-level encodings to convert the textual features into numeric representations. In many embodiments, block 840 can be implemented as described above in connection with block 610 (FIG. 6).

In some embodiments, block 840 of generating the first sub-model additionally can include sending the character-level encodings into a first embedding layer to generate a first embedding. In various embodiments, the first embedding layer can be trained to remove sparsity from the character-level encodings. In many embodiments, block 840 can be implemented as described above in connection with block 620 (FIG. 6).

In many embodiments, block 840 of generating the first sub-model further can include sending the first embedding to an encoder block to generate final encodings. In several embodiments, the encoder block comprises a transformer using multi-head attention and a first fully connected layer using a Siamese architecture in which the encoder block is shared between two textual features. In many embodiments, block 840 can be implemented as described above in connection with block 620, 630 and 635 (FIG. 6).

In various embodiments, block 840 of generating the first sub-model also can include calculating an absolute difference between the final encodings. In many embodiments, block 840 can be implemented as described above in connection with block 620 (FIG. 6).

In several embodiments, block 840 of generating the first sub-model further can include passing each difference of each textual feature encoding into a second fully connected layer. In many embodiments, block 840 can be implemented as described above in connection with block 620 (FIG. 6).

In a number of embodiments, block 840 additionally can include generating the second sub-model by processing the boolean features using multiple fully connected layers. In many embodiments, block 840 can be implemented as described above in connection with block 650, 651, and 660 (FIG. 6).

In various embodiments, block 840 also can include determining the match probability can include concatenating each output of the first sub-model and the second sub-model to generate a combined output. In some embodiments, determining the match probability additionally can include passing the combined output, as concatenated, into a final fully connected layer. In many embodiments, determining the match probability further can include outputting the match probability. In many embodiments, block 840 can be implemented as described above in connection with block 670 (FIG. 6).

In a number of embodiments, the weights of deep-learning transformer-based binary classification model can be tuned using a binary cross-entropy loss function.

In many embodiments, method 800 additionally can include a block 850 of generating, using a connected component algorithm, clusters each containing identities representing a respective user. In many embodiments, block 850 can be implemented as described above in connection with blocks 560 (FIG. 5) and/or 690 (FIG. 6).

In some embodiments, method 800 also can include a block 860 of generating a respective user profile for the respective user for each cluster. In many embodiments, block 860 can be implemented as described above in connection with blocks 560 (FIG. 5), block 690 (FIG. 6), and/or FIGS. 4 and 7.

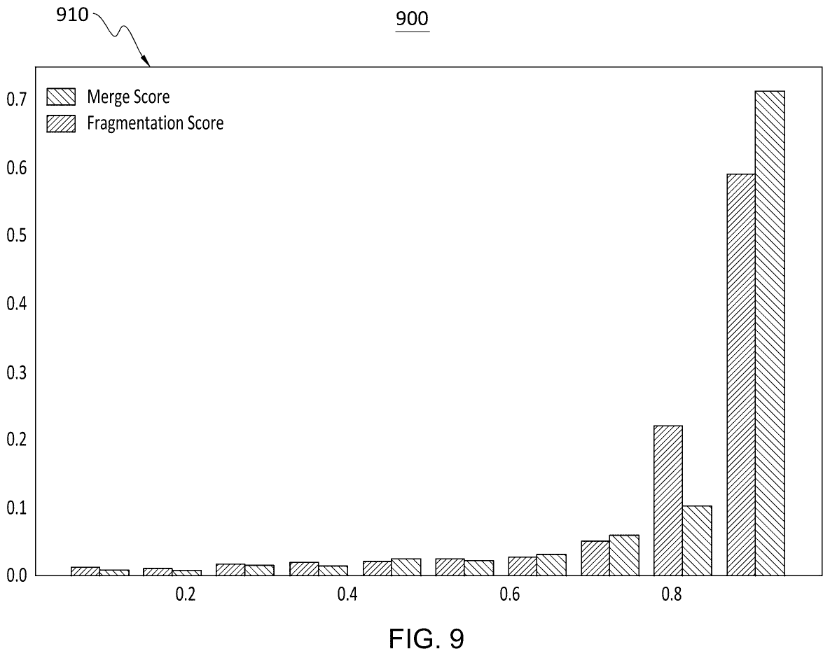

Moving ahead in the drawings, FIG. 9 illustrates a chart 900 showing how a distribution of merge scored and fragmentation scores for all user clusters created by a production pipeline. Chart 900 includes an x-axis label: “Score” and y-axis label: “Portion of Total Number of Clusters”. Chart 900 illustrates a majority of clusters in this distribution can have scores of approximately 0.7.

Turning back in the drawings, machine learning system 311 can at least partially perform block 570 (FIG. 5) of evaluating, using a score generation algorithm the performance of the clusters using quality scores, ***block 651 (FIG. 6) of running boolean sub-models, each of which can consist of fully connected layers (e.g., a block 660), block 660 (FIG. 6) of inputting the Boolean features into two fully connected layers where each of the outputs of each boolean sub-model are then concatenated and passed into a final fully connected layer, block 670 (FIG. 6) of merging layers, block 680 (FIG. 6) of inputting reconfigured data output by block 670, block 690 (FIG. 6) of outputting the probability of an entity match, block 820 (FIG. 8) of determining a match probability for the respective pair of identities using a deep-learning transformer-based binary classification model, block 825 (FIG. 8) of generating a probabilistic set of labels for an unlabeled training dataset to output a labeled training dataset, and/or block 830 (FIG. 8) of training the deep-learning transformer-based binary classification model using the labeled training dataset.

In some embodiments, generating system 312 can at least partially perform block 530 of creating pairs of records using data from the blocks created from user records, block 550 (FIG. 5) of generating, using linkage creation, one or more graphs where each identity can be viewed as a node linked to another node, block 630 (FIG. 6) of processing a series of textual sub-models, block 640 (FIG. 6) of inputting Boolean features (e.g., values) for each entity pair, and/or block 810 (FIG. 8) of generating pairs of identities from a plurality of sources,

In several embodiments, matching system 313 can at least partially perform block 520 (FIG. 5) of creating blocks of groups of records (e.g., profiles) that can share the same user, block 540 (FIG. 5) of determining, using a matching model, a model prediction (e.g., score) for each respective pair of identities, and/or block 860 (FIG. 8) of generating a respective user profile for the respective user for each cluster.

In various embodiments, communication system 314 can at least partially perform block 510 (FIG. 5) of retrieving identity data from records associated with a user.

In many embodiments, graphing system 315 can at least partially block 560 (FIG. 5) of generating connected component graphs by clusters, block 840 (FIG. 8) of linking the respective pair of identities as nodes on a graph when the match probability meets a predetermined threshold, block 850 (FIG. 8) of generating, using a connected component algorithm, clusters each containing identities representing a respective user,

In some embodiments, embedding system 316 can at least partially perform block 630 (FIG. 6) of processing a series of textual sub-models, and/or block 640 (FIG. 6) of inputting Boolean features (e.g., values) for each entity pair.

In several embodiments, encoding system 317 can at least partially perform block 610 (FIG. 6) of inputting text features (e.g., raw textual attributes) for each entity pair, and/or block 620 (FIG. 6) of removing sparsity from the character-level encoding passed into an embedding layer.

In various embodiments, concatenating system 318 can at least partially perform block 651 (FIG. 6) of running boolean sub-models, each of which can consist of fully connected layers 660 where each of the outputs of each boolean sub-model are then concatenated and passed into a final fully connected layer.

In some embodiments, training system 319 can at least partially perform block 825 (FIG. 8) of generating a probabilistic set of labels for an unlabeled training dataset to output a labeled training dataset, and/or block 830 (FIG. 8) of training the deep-learning transformer-based binary classification model using the labeled training dataset.

In several embodiments, measuring system 322 can at least partially perform block 570 (FIG. 5) of evaluating, using a score generation algorithm the performance of the clusters using quality scores.

In some embodiments, web server 320 can include a webpage system 321. Webpage system 321 can at least partially perform sending instructions to user computers (e.g., 350-351 (FIG. 3)) based on information received from communication system 314.

In many embodiments, an advantage of using the deep learning entity matching model, such as POMMEL, is to enable future works to train, evaluate, and benchmark performance. POMMEL illustrates the efficacy of using weak supervision to train an EM system when lacking manually labeled data. In various embodiments, the data pipeline and transformer-based matching algorithm outperforms existing state-of-the-art EM models. POMMEL also uses two new quality metrics (the merge score and the fragmentation score) that can advantageously measure the performance of identity clustering systems by using domain knowledge and statistical approximations rather than conventional manual labelling approaches.

In many embodiments, the techniques described herein can be used continuously at a scale that cannot be handled using manual techniques. For example, the number of daily and/or monthly interaction with multiple sources can exceed one billion visits to a content source by users.

In many embodiments, test results based on the POMMEL entity matching model using internal customer data can be shown to be a technological improvement as compared to three open-source state-of-the-art deep learning entity matching systems: DeepMatcher, DITTO, and HierMatcher. The internal dataset used to evaluate the test models include 100,000 pairs of real customer identities. Two types of experiments to compare performance of models on this dataset were conducted. For the first experiment, labels were first generated via Snorkel and then used as training datasets to train each of the three models in the test. In order to compare accuracies, 10,000 of these pairs were manually labeled which made up the final test set. Further, the training and validation sets included 70,000 and 20,000 points, respectively. POMMEL outperformed all three existing architectures by an average margin of 2.67% in an F1 score.

In some embodiments, the high performance of the deep learning entity matching models, even when trained on labels generated through weak supervision, illustrates the advantages and benefits of using Snorkel for entity matching. The test results eliminated high operational costs of acquiring manually labeled data which in many cases can be almost impossible to operate at a large scale level due to the privacy requirements of customer data. The test results also demonstrated the advantageous performance improvements when using a transformer-based architecture and character-level encodings for entity matching.

Further, POMMEL, unlike product matching, which can benefit from using pre-trained NLP models (as DITTO observes), identity matching contains a unique combination of textual and boolean attributes. Using character-level embeddings advantageously allows for POMMEL to create more meaningful representations of textual customer features that can lead to higher technology performances when compared to the baseline conventional models. Furthermore, when using manually labeled customer data, a label of 0.0 or 1.0 can be attached to each point. On the other hand, when generating weakly supervised labels, Snorkel outputs probabilistic labels ranging between 0.0 and 1.0 rather than a binary label.

Another advantage of POMMEL is in using these probabilistic labels as a training data to train the deep learning entity matching model. In many embodiments, probabilistic labels can include more information regarding the nature of a match or no match. And some data points that have sparse feature sets can make it difficult to attach a binary label even for a human labeler. An advantage of POMMEL using probabilistic scores instead, shows that POMMEL performs competitively, and in some cases outperforms, with the baseline models trained on manually labeled data.

In various embodiments, POMMEL, an entity matching pipeline focused on clustering user identities. POMMEL demonstrated the superior performance of a transformer-based deep learning model for identity matching when compared to rule-based systems and other deep learning EM systems. POMMEL showed the efficacy of using weak supervision to generate labels used to train a deep learning matching entity model (e.g., machine learning model).

In some embodiments, given that identity matching is fundamentally a graph clustering problem, an advantage of using graph networks can lead to a more effective end-to-end identity resolution pipeline. Using neighborhood information can provide more information when making a decision regarding a match. Features such as past transaction trends, categories of product purchases, other demographics, etc. can help reduce sparsity in the current feature vectors for each identity, thus leading to more accurate customer clusters.

Various embodiments can include a system including one or more processors and one or more non-transitory computer-readable media storing computing instructions that, when executed on the one or more processors, cause the one or more processors to perform certain acts. The acts can include generating pairs of identities from a plurality of sources. For each respective pair of identities of the pairs of identities, the acts also can include determining a match probability for the respective pair of identities using a deep-learning transformer-based binary classification model. For each respective pair of identities of the pairs of identities, the acts further can include linking the respective pair of identities as nodes on a graph when the match probability meets a predetermined threshold. A linkage between the nodes can represent a match for the respective pair of identities. The acts additionally can include generating, using a connected component algorithm, clusters each containing identities representing a respective user. The acts also can include generating a respective user profile for the respective user for each cluster.

A number of embodiments can include a method being implemented via execution of computing instructions configured to run at one or more processors and stored at one or more non-transitory computer-readable media. The method can include receiving, generating pairs of identities from a plurality of sources. For each respective pair of identities of the pairs of identities, the method also can include determining a match probability for the respective pair of identities using a deep-learning transformer-based binary classification model. For each respective pair of identities of the pairs of identities, the method further can include linking the respective pair of identities as nodes on a graph when the match probability meets a predetermined threshold. A linkage between the nodes can represent a match for the respective pair of identities. The method additionally can include generating, using a connected component algorithm, clusters each containing identities representing a respective user. The method also can include generating a respective user profile for the respective user for each cluster.

Although automatically generating a respective user profile for the respective user for each cluster by deep learning entity matching using weak supervision has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 3-9 may include different procedures, processes, and/or activities and be performed by many different modules, in many different orders, and/or one or more of the procedures, processes, or activities of FIGS. 3-9 may include one or more of the procedures, processes, or activities of another different one of FIGS. 3-9. Additional details regarding deep learning entity matching system 310, machine learning system 311, generating system 312, matching system 313, communication system 314, graphing system 315, embedding system 316, encoding system 317, concatenating system 318, training system 319, measuring system 322, web server 320 and/or webpage system 321, (see FIGS. 3 and 9) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents

What is claimed is:

1. A system comprising:
one or more processors; and
one or more non-transitory computer-readable media storing computing instructions that, when executed on the one or more processors, cause the one or more processors to perform functions comprising:
generating pairs of identities from a plurality of sources;
for each respective pair of identities of the pairs of identities:
determining a match probability for the respective pair of identities using a deep-learning transformer-based binary classification model; and
linking the respective pair of identities as nodes on a graph when the match probability meets a predetermined threshold, wherein a linkage between the nodes represents a match for the respective pair of identities;
generating, using a connected component algorithm, clusters each containing identities representing a respective user; and
generating a respective user profile for the respective user for each cluster.

2. The system of claim 1, wherein the computing instructions, when executed on the one or more processors, further cause the one or more processors to perform functions comprising:
generating a probabilistic set of labels for an unlabeled training dataset to output a labeled training dataset; and
training the deep-learning transformer-based binary classification model using the labeled training dataset.

3. The system of claim 2, wherein the probabilistic set of labels is generated using heuristic functions.

4. The system of claim 2, wherein generating the probabilistic set of labels uses a weak supervision model.

5. The system of claim 1, wherein determining the match probability comprises:
obtaining textual features for each identity of the respective pair of identities, wherein each of the textual features comprises unique string length distributions; and
generating a first sub-model based on the textual features.

6. The system of claim 5, wherein determining the match probability further comprises:
obtaining boolean features for each identity of the respective pair of identities, wherein the boolean features comprise external metadata and transaction history; and
generating a second sub-model based on the boolean features.

7. The system of claim 6, wherein generating the first sub-model comprises:
generating character-level encodings to convert the textual features into numeric representations;
sending the character-level encodings into a first embedding layer to generate a first embedding, wherein the first embedding layer is trained to remove sparsity from the character-level encodings;
sending the first embedding to an encoder block to generate final encodings, wherein the encoder block comprises a transformer using multi-head attention and a first fully connected layer using a Siamese architecture in which the encoder block is shared between two textual features;
calculating an absolute difference between the final encodings; and
passing each difference of each textual feature encoding into a second fully connected layer.

8. The system of claim 7, wherein generating the second sub-model comprises:
processing the boolean features using multiple fully connected layers.

9. The system of claim 8, wherein determining the match probability further comprises:
concatenating each output of the first sub-model and the second sub-model to generate a combined output;
passing the combined output, as concatenated, into a final fully connected layer; and
outputting the match probability.

10. The system of claim 9, wherein weights of deep-learning transformer-based binary classification model are tuned using a binary cross-entropy loss function.

11. A method being implemented via execution of computing instruction configured to run on one or more processors and stored at one or more non-transitory computer-readable media, the method comprising:
generating pairs of identities from a plurality of sources;
for each respective pair of identities of the pairs of identities:
determining a match probability for the respective pair of identities using a deep-learning transformer-based binary classification model; and
linking the respective pair of identities as nodes on a graph when the match probability meets a predetermined threshold, wherein a linkage between the nodes represents a match for the respective pair of identities;
generating, using a connected component algorithm, clusters each containing identities representing a respective user; and
generating a respective user profile for the respective user for each cluster.

12. The method of claim 11, further comprising:
generating a probabilistic set of labels for an unlabeled training dataset to output a labeled training dataset; and
training the deep-learning transformer-based binary classification model using the labeled training dataset.

13. The method of claim 12, wherein the probabilistic set of labels is generated using heuristic functions.

14. The method of claim 12, wherein generating the probabilistic set of labels uses a weak supervision model.

15. The method of claim 11, wherein determining the match probability comprises:
obtaining textual features for each identity of the respective pair of identities, wherein each of the textual features comprises unique string length distributions; and
generating a first sub-model based on the textual features.

16. The method of claim 15, wherein determining the match probability further comprises:
obtaining boolean features for each identity of the respective pair of identities, wherein the boolean features comprise external metadata and transaction history; and
generating a second sub-model based on the boolean features.

17. The method of claim 16, wherein generating the first sub-model comprises:
generating character-level encodings to convert the textual features into numeric representations;
sending the character-level encodings into a first embedding layer to generate a first embedding, wherein the first embedding layer is trained to remove sparsity from the character-level encodings;
sending the first embedding to an encoder block to generate final encodings, wherein the encoder block comprises a transformer using multi-head attention and a first fully connected layer using a Siamese architecture in which the encoder block is shared between two textual features;
calculating an absolute difference between the final encodings; and
passing each difference of each textual feature encoding into a second fully connected layer.

18. The method of claim 17, wherein generating the second sub-model comprises:
processing the boolean features using multiple fully connected layers.

19. The method of claim 18, wherein determining the match probability further comprises:
concatenating each output of the first sub-model and the second sub-model to generate a combined output;
passing the combined output, as concatenated, into a final fully connected layer; and
outputting the match probability.

20. The method of claim 19, wherein weights of deep-learning transformer-based binary classification model are tuned using a binary cross-entropy loss function.
